(19) United States
(12) Patent Application Publication
(10) Pub. No.: US 2017/0142478 A1
(43) Pub. Date: May 18, 2017

(54) METHOD AND DEVICE FOR DETECTING SHIELDED WiHD DATA PROJECTION CHANNEL

(71) Applicants: LE HOLDINGS (BEIJING) CO., LTD., Beijing (CN); Lemobile Information Technology (Beijing) Co., Ltd., Beijing (CN)

(72) Inventors: Yaqiong LIU, Beijing (CN); Jingyu HU, Beijing (CN)

(21) Appl. No.: 15/249,155

(22) Filed: Aug. 26, 2016

Related U.S. Application Data
(63) Continuation of application No. PCT/CN2016/087406, filed on Jun. 28, 2016.

(30) Foreign Application Priority Data
Nov. 13, 2015 (CN) 201510781130.8

(51) Int. Cl. H04N 21/4363; H04N 21/472; H04N 21/435; H04N 21/41

(52) U.S. Cl. CPC H04N 21/43637; H04N 21/4126; H04N 21/47214; H04N 21/435

(57) ABSTRACT

The embodiment of the present disclosure provides a method and a device for detecting a shielded WiHD data projection channel. The method comprises: establishing a WiHD data projection channel between a mobile terminal and a WiHD data receiver; transmitting a verification message to the WiHD data receiver through the WiHD data projection channel; determining whether a response message is received or not; if not, generating an event that the state of the WiHD data projection channel is changed; displaying the prompting indicating that the WiHD data projection channel is shielded according to the event. According to the present disclosure, when the response message is not received, the situation means that the WiHD data projection channel is shielded, and then the prompting of shielding may be displayed to prompt a user to adjust the position of the mobile terminal so as to eliminate shielding.

### CROSS-REFERENCE TO RELATED APPLICATIONS

This application is a continuation of International Application No. PCT/CN2016/087406, filed on Jun. 28, 2016, which is based upon and claims priority to Chinese Patent Application No. 201510781130.8, filed on Nov. 13, 2015, the entire contents of which are incorporated herein by reference.

### TECHNICAL FIELD

The disclosure relates to the technical field of intelligent terminals, and in particular to a method and a device for detecting a shielded WiHD data projection channel.

### BACKGROUND

WiHD (Wireless hdmi) is a WiHD video transmission protocol operated at a high frequency of 60 GHz. By using the WiHD technology, high quality, high-definition and uncompressed videos may be stably and reliably transmitted and shared and played among multiple pieces of electronic device by users. Compared with Wi-Fi (Wireless-Fidelity), WiHD has support of 1080P and 3D, and is farther in transmission distance.

However, for a wireless signal, on a same frequency, the higher the signal frequency is, the more intensive the signal directivity is, and when the signal penetrates through an obstacle, the larger the energy loss is, the poorer the diffraction performance is. Therefore, under the influence of the transmission distance and signal shielding, a user may have the problem of unstable connection or connection signal interruption when transmitting a high-definition video by using the WiHD technology. Moreover, once the problem happens, the user cannot confirm that whether the problem happens to the mobile terminal, an intelligent television or a WiHD data receiver.

Therefore, one technical problem which needs to be solved urgently by technicians of the field at present is to find the fault and eliminate shielding in time in case of unstable connection or connection signal interruption when WiHD data are transmitted by using the WiHD technology.

### SUMMARY

The embodiment of the present disclosure discloses a method and a device for detecting a shielded WiHD data projection channel, and aims to solve the defects that in the prior art the fault cannot be positioned or shielding cannot be eliminated in time in case of unstable connection or connection signal interruption when WiHD data are transmitted by using the WiHD technology.

According to one aspect of the present disclosure, the embodiment of the present disclosure discloses a method for detecting a shielded WiHD data projection channel, including: establishing a WiHD data projection channel between a mobile terminal and a WiHD data receiver; transmitting a verification message to the WiHD data receiver through the WiHD data projection channel; determining whether a response message fed back from the WiHD data receiver according to the verification message is received or not; if the response message is not received, generating an event that the state of the WiHD data projection channel is changed; displaying the prompting indicating that the WiHD data projection channel is shielded according to the event that the state of the WiHD data projection channel is changed.

To solve the problem, the embodiment of the present disclosure discloses an electronic device for detecting a shielded WiHD data projection channel, including: at least one processor; and a memory communicably connected with the at least one processor for storing instructions executable by the at least one processor, wherein execution of the instructions by the at least one processor causes the at least one processor to: establish a WiHD data projection channel with a WiHD data receiver; transmit a verification message to the WiHD data receiver through the WiHD data projection channel; determine whether a response message fed back from the WiHD data receiver according to the verification message is received or not; generate an event that the state of the WiHD data projection channel is changed if the response message is not received; display the prompting indicating that the WiHD data projection channel is shielded according to the event that the state of the WiHD data projection channel is changed.

According to another aspect of the present disclosure, the present disclosure provides a non-transitory computer readable medium storing executable instructions that, when executed by an electronic device, cause the electronic device to: establish a WiHD data projection channel with a WiHD data receiver; transmit a verification message to the WiHD data receiver through the WiHD data projection channel; determine whether a response message fed back from the WiHD data receiver according to the verification message is received or not; generate an event that the state of the WiHD data projection channel is changed if the response message is not received; display the prompting indicating that the WiHD data projection channel is shielded according to the event that the state of the WiHD data projection channel is changed.

The present disclosure has the beneficial effects that: according to the method and the device which are used for detecting the shielded WiHD data projection channel and are provided by the embodiments of the present disclosure, the mobile terminal is adopted to transmit the verification message to the WiHD data receiver and determine whether the response message which is fed back from the WiHD data receiver is received or not, if the response message is not received, the situation means that the WiHD data projection channel between the mobile terminal and the WiHD data receiver is shielded, and then the prompting indicating that the WiHD data projection channel is shielded may be displayed to prompt a user to adjust the positions of the WiHD data receiver and the mobile terminal in time so as to eliminate shielding.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 shows the connection block frame for WiHD data transmission between the mobile terminal and the intelligent television provided by the embodiments of the present disclosure.

FIG. 2 shows the step flow chart of the method for detecting the shielded WiHD data projection channel provided by the embodiment I of the present disclosure.

FIG. 3 shows the step flow chart of the method for detecting the shielded WiHD data projection channel provided by the embodiment II of the present disclosure.

FIG. 4 shows the structure block diagram of the device for detecting the shielded WiHD data projection channel provided by the embodiment III of the present disclosure.

FIG. 5 shows the structure block diagram of the device for detecting the shielded WiHD data projection channel provided by the embodiment IV of the present disclosure.

FIG. 6 schematically shows the block diagram of an electronic device for executing the method of the present disclosure.

FIG. 7 schematically shows the storage unit for storing or carrying the program codes for realizing the method of the present disclosure.

### DETAILED DESCRIPTION

To make the purposes, the technical schemes and the advantages of the embodiments of the present disclosure clearer, the technical schemes of the embodiments of the present disclosure are clearly and completely described together with the figures of the embodiments of the present disclosure. Obviously, the described embodiments are a part of but not all ones of the present disclosure. Based on the embodiments of the present disclosure, other embodiments obtained by the common technicians without any creative work all belong to the protection scope of the present disclosure.

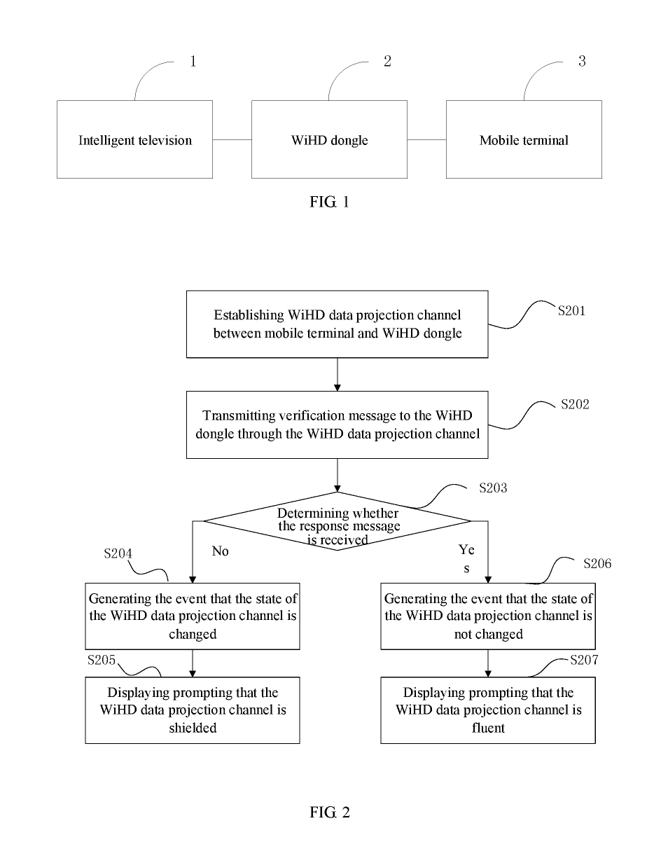

FIG. 1 shows the connection block diagram for WiHD data transmission between the mobile terminal and the intelligent television. As shown in FIG. 1, the intelligent television 1 is integrated with the WiHD data receiver 2, the WiHD data projection channel is established between the mobile terminal 3 and the WiHD data receiver, the high-definition video in the mobile terminal 3 may be pushed to the WiHD data receiver 2 through the WiHD data projection channel and is furthermore transmitted to the intelligent television 1 from the WiHD data receiver, so that on-screen-display of the mobile terminal 3 and the intelligent television 1 may be achieved.

Based on the principle, the embodiment of the present disclosure provides the method and the device for detecting the shielded WiHD data projection channel, then the fault that the connection is not stable or the connection signal is interrupted when the high-definition data are transmitted by using the WiHD (Wireless hdmi) technology may be positioned, and the problem of shielding may be eliminated in time.

Embodiment I

The FIG. 2 shows the step flow chart of the method for detecting the shielded WiHD data projection channel provided by the embodiment I of the present disclosure.

The embodiment of the present disclosure provides the method for detecting the shielded WiHD data projection channel, as shown in FIG. 1, including the steps as follows.

S201, establishing the WiHD data projection channel between the mobile terminal and the WiHD data receiver.

In the step, the mobile terminal may be terminals such as a mobile phone and a tablet personal computer with a video play function and a WiHD function. Before the WiHD data projection channel is established between the WiHD data receiver and the mobile terminal, the WiHD function of the mobile terminal shall be powered on. The mobile terminal may be in WiHD connection with the WiHD data receiver by reading the connection information in an NFC (Near Field Communication) tag, so that the WiHD data projection channel may be established. The connection information may include marking information and address information of the WiHD data receiver.

S202, transmitting the verification message to the WiHD data receiver through the WiHD data projection channel.

In the step, the verification message may be a fixed message. Preferably, the verification message may be transmitted to the WiHD data receiver through the WiHD data projection channel in the preset cycles, and the preset cycles may be 100 ms.

S203, determining whether the response message which is fed back from the WiHD data receiver according to the verification message is received or not.

In the step, after receiving the verification message, the WiHD data receiver may feed back the response message to the mobile terminal. If the mobile terminal does not receive the response message, implement the step S204; if the response message is received, implement the step S206.

S204, generating the event that the state of the WiHD data projection channel is changed.

In the step, the generation of the event that the state of the WiHD data projection channel is changed means the WiHD data projection channel is shielded by obstacle.

S205, displaying the prompting indicating that the WiHD data projection channel is shielded according to the event that the state of the WiHD data projection channel is changed.

In the step, the user may adjust the positions of the WiHD data receiver and the mobile terminal in time according to the prompting, so as to eliminate shielding.

S206, generating an event that the state of the WiHD data projection channel is not changed.

In the step, the event means that the mobile terminal and the WiHD data receiver may both work normally, and the WiHD data projection channel is not shielded.

S207, displaying the prompting indicating that the WiHD data projection channel is fluent according to the event that the state of the WiHD data projection channel is not changed.

In the step, if the prompting indicating that the WiHD data projection channel is fluent is displayed on the mobile terminal, but on-screen-display of the mobile terminal and the intelligent television still cannot be achieved, the situation may be determined as intelligent television fault.

According to the method for detecting the shielded WiHD data projection channel provided by the embodiment I of the present disclosure, the mobile terminal transmits the verification message to the WiHD data receiver and determines whether the response message fed back from the WiHD data receiver is received or not; if the response message is not received, the situation means that the WiHD data projection channel between the mobile terminal and the WiHD data receiver is shielded, prompting indicating that the WiHD data projection channel is shielded is displayed to prompt the user to adjust the positions of the WiHD data receiver and the mobile terminal in time so as to eliminate shielding.

In preferable embodiments of the present disclosure, the step S203 may be optimized as that within the preset time, determining whether the response message fed back from the WiHD data receiver according to the verification message is received or not; correspondingly, the step S204 may be optimized as that if the response message is not received within the preset time, generating the event that the state of the WiHD data projection channel is changed. The preset time may be 200 ms. Therefore, the efficiency in determining that the WiHD data projection channel between the mobile terminal and the WiHD data receiver is shielded may be improved.

Embodiment II

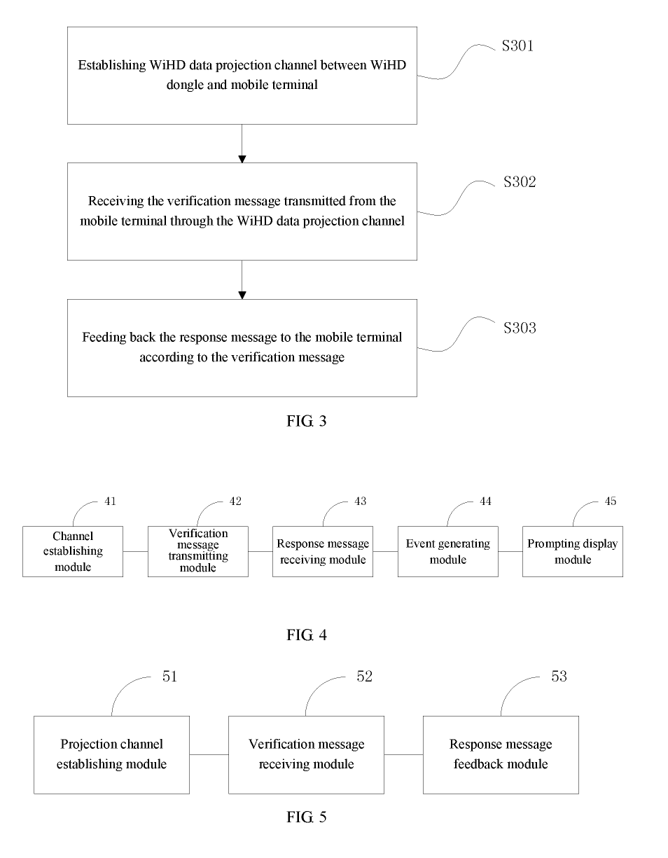

FIG. 3 shows the step flow chart of the method for detecting the shielded WiHD data projection channel provided by the embodiment II of the present disclosure.

The embodiment II of the present disclosure provides the method for detecting the shielded WiHD data projection channel, as shown in FIG. 3, including steps as follows.

S301, establishing the WiHD data projection channel between the WiHD data receiver and the mobile terminal.

In the step, the WiHD data receiver may be used for receiving the connection information transmitted from the mobile terminal and used for verifying whether the connection information is correct or not, the connection information may include the marking information and the address information of the WiHD data receiver, and if the connection information is correct, the WiHD data projection channel may be established between the WiHD data receiver and the mobile terminal.

S302, receiving the verification message transmitted from the mobile terminal through the WiHD data projection channel.

S303, feeding back the response message to the mobile terminal according to the verification message.

According to the method for detecting the shielded WiHD data projection channel provided by the embodiment II of the present disclosure, the verification message transmitted from the mobile terminal may be received, and the response message may be fed back to the mobile terminal; if the WiHD data receiver does not receive the verification message, the situation means that the WiHD data projection channel between the mobile terminal and the WiHD data receiver is shielded, and prompting indicating that the WiHD data projection channel is shielded is displayed to prompt the user to adjust the positions of the WiHD data receiver and the mobile terminal in time so as to eliminate shielding.

Embodiment III

The FIG. 4 shows the structure block diagram of the device for detecting the shielded WiHD data projection channel provided by the embodiment III of the present disclosure.

The embodiment III of the present disclosure provides the device for detecting the shielded WiHD data projection channel, the device may execute the method for detecting the shielded WiHD data projection channel provided by the embodiment I of the present disclosure, and as shown in FIG. 4, the device includes modules of: a channel establishing module 41, a verification message transmitting module 42, a response message receiving module 43, an event generating module 44 and a prompting display module 45.

In the embodiment of the present disclosure, the channel establishing module 41 is used for establishing the WiHD data projection channel with the WiHD data receiver; the verification message transmitting module 42 is used for transmitting the verification message to the WiHD data receiver through the WiHD data projection channel; the response message receiving module 43 is used for determining whether the response message fed back from the WiHD data receiver according to the verification message is received or not; the event generating module 44 is used for generating the event that the state of the WiHD data projection channel is changed if the response message is not received; the prompting display module 45 is used for displaying the prompting indicating that the WiHD data projection channel is shielded according to the event that the state of the WiHD data projection channel is changed.

In the channel establishing module 41, WiHD connection with the WiHD data receiver may be established by reading the connection information in the NFC (Near Field Communication) tag, so as to establish the WiHD data projection channel. The connection information may include the marking information and the address information of the WiHD data receiver.

In the verification message transmitting module 42, the verification message may be fixed message. Preferably, the verification message is transmitted to the WiHD data receiver through the WiHD data projection channel in the preset cycles, and the preset cycles may be 100 ms.

In the response message receiving module 43, the WiHD data receiver may feed back the response message to the response message receiving module 43 after receiving the verification message.

In the event generating module 44, if the response message is not received, the event that the state of the WiHD data projection channel is changed may be generated, and the situation means that the WiHD data projection channel is shielded by obstacle; if the response message is received, the event that the state of the WiHD data projection channel is not changed may be generated, the situation means that the mobile terminal and the WiHD data receiver may both work normally, and the WiHD data projection channel is not shielded.

In the prompting display module 45, the prompting indicating that the WiHD data projection channel is shielded may be displayed according to the event that the state of the WiHD data projection channel is changed, and moreover the prompting indicating that the WiHD data projection channel is fluent may be displayed according to the event that the state of the WiHD data projection channel is not changed.

According to the device for detecting the shielded WiHD data projection channel provided by the embodiment III of the present disclosure, the verification message may be transmitted to the WiHD data receiver, and whether the response message fed back from the WiHD data receiver is received or not may be determined; if the response message is not received, the situation means that the WiHD data projection channel between the mobile terminal and the WiHD data receiver is shielded, the prompting indicating that the WiHD data projection channel is shielded may be displayed to prompt the user to adjust the positions of the WiHD data receiver and the mobile terminal in time so as to eliminate shielding.

In preferable embodiments of the present disclosure, the response message receiving module 43 is specifically used for determining whether the response message fed back from the WiHD data receiver according to the verification message is received or not within the preset time; the event generating module 44 is specifically used for generating the event that the state of the WiHD data projection channel is changed if the response message is not received within the preset time. The preset time may be 200 ms. Therefore, the efficiency in determining whether the WiHD data projection channel between the mobile terminal and the WiHD data receiver is shielded or not may be improved.

Embodiment IV

The FIG. 5 shows the structure block diagram of the device for detecting the shielded WiHD data projection channel provided by the embodiment IV of the present disclosure.

The embodiment IV of the present disclosure provides the device for detecting the shielded WiHD data projection channel, the device may execute the method for detecting the shielded WiHD data projection channel provided by the embodiment II of the present disclosure, and as shown in FIG. 5, including: the projection channel establishing module 51, the verification message receiving module 52 and the response message feedback module 53.

In the embodiment of the present disclosure, the projection channel establishing module 51 is used for establishing the WiHD data projection channel with the mobile terminal; the verification message receiving module 52 is used for receiving the verification message transmitted from the mobile terminal through the WiHD data projection channel; the response message feedback module 53 is used for feeding back the response message through the WiHD data projection channel.

In the projection channel establishing module 51, the connection information transmitted from the mobile terminal may be received, and the connection information may include the marking information and the address information of the WiHD data receiver. Moreover whether the connection information is correct or not may be verified, and if the connection information is correct, the WiHD data projection channel may be established with the mobile terminal.

According to the device for detecting the shielded WiHD data projection channel provided by the embodiment IV of the present disclosure, the verification message transmitted from the mobile terminal may be received, and the response message may be fed back to the mobile terminal; if the WiHD data receiver does not receive the verification message, the situation means that the WiHD data projection channel between the mobile terminal and the WiHD data receiver is shielded, the prompting that the WiHD data projection channel is shielded is displayed to prompt the user to adjust the positions of the WiHD data receiver and the mobile terminal in time so as to eliminate shielding.

The embodiment of the present disclosure further provides a mobile terminal which includes the device for detecting the shielded WiHD data projection channel in the embodiment III, and the mobile terminal may be terminals such as a mobile phone and a tablet personal computer with a video play function and a WiHD (Wireless hdmi) function.

The embodiment of the present disclosure further provides the WiHD data receiver which includes the device for detecting the shielded WiHD data projection channel in the embodiment IV, and the WiHD data receiver may be integrated in the intelligent television.

The embodiments of the device described above are only schematic, a unit which may be explained as a separated part may be or not physically separated, a member for unit display may be or not a physical unit, that is, the member may be located at one place or distributed to multiple network units. A part of or all modules may be selected to achieve the purposes of the schemes of the embodiments according to practical demands. The present disclosure may be understood and implemented by common technicians of the field without creative work.

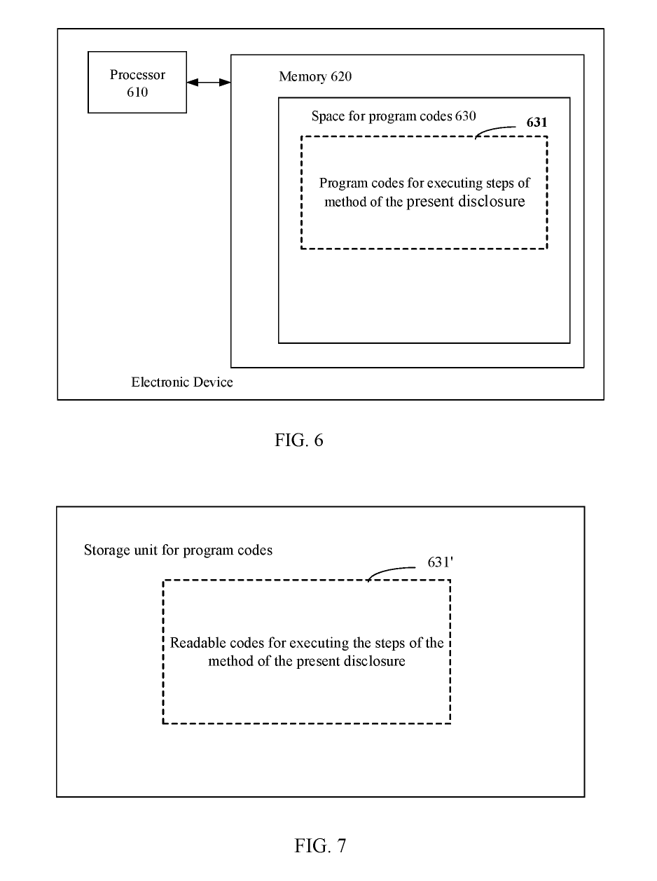

For example, FIG. 6 illustrates a block diagram of an electronic device for executing the method for detecting a shielded WiHD data projection channel according the disclosure. Traditionally, the electronic device includes a processor 610 and a computer program product or a computer readable medium in form of a memory 620. The memory 620 could be electronic memories such as flash memory, EEPROM (Electrically Erasable Programmable Read - Only Memory), EPROM, hard disk or ROM. The memory 620 has a memory space 630 for executing program codes 631 of any steps in the above methods. For example, the memory space 630 for program codes may include respective program codes 631 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 7. The memory cells may be provided with memory sections, memory spaces, etc., similar to the memory 620 of the server as shown in FIG. 6. The program codes may be compressed for example in an appropriate form. Usually, the memory cell includes computer readable codes 631′ which may be read for example by processors 610. When these codes are operated on the server, the server may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure may be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments may be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings may be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

The final description is that the previous embodiments are not used for limiting the technical scheme of the present disclosure, but only for describing. Although detailed description of the present disclosure is given with reference to the previous embodiments, the common technicians of the field should understand that the technical scheme recorded by each of the previous embodiments may be modified, or one part of technical characteristics may be equivalently replaced; however, the modification or replacement does not enable the essence of the corresponding technical scheme to get out of the spirit and scope of the technical scheme in each embodiment of the present disclosure.

What is claimed is:

1. A method for detecting a shielded WiHD data projection channel, comprising:
establishing a WiHD data projection channel between a mobile terminal and a WiHD data receiver;
transmitting a verification message to the WiHD data receiver through the WiHD data projection channel;
determining whether a response message fed back from the WiHD data receiver according to the verification message is received or not;
if the response message is not received, generating an event that the state of the WiHD data projection channel is changed;
displaying the prompting indicating that the WiHD data projection channel is shielded according to the event that the state of the WiHD data projection channel is changed.

2. The method according to claim 1, wherein transmitting the verification message to the WiHD data receiver through the WiHD data projection channel comprises:
transmitting the verification message to the WiHD data receiver through the WiHD data projection channel in preset cycles.

3. The method according to claim 1, wherein determining whether the response message fed back from the WiHD data receiver according to the verification message is received or not, if the response message is not received, generating an event that the state of the WiHD data projection channel is changed comprises:
determining whether the response message fed back from the WiHD data receiver according to the verification message is received or not within a preset time;
if the response message is not received within the preset time, generating an event that the state of the WiHD data projection channel is changed.

4. An electronic device for detecting a shielded WiHD data projection channel, comprising:
at least one processor; and
a memory communicably connected with the at least one processor for storing instructions executable by the at least one processor, wherein execution of the instructions by the at least one processor causes the at least one processor to:
establish a WiHD data projection channel with a WiHD data receiver;
transmit a verification message to the WiHD data receiver through the WiHD data projection channel;
determine whether a response message fed back from the WiHD data receiver according to the verification message is received or not;
generate an event that the state of the WiHD data projection channel is changed if the response message is not received;
display the prompting indicating that the WiHD data projection channel is shielded according to the event that the state of the WiHD data projection channel is changed.

5. The electronic device according to claim 4, wherein transmitting a verification message to the WiHD data receiver through the WiHD data projection channel comprises: transmitting the verification message to the WiHD data receiver through the WiHD data projection channel in preset cycles.

6. The electronic device according to claim 4, wherein determine whether a response message fed back from the WiHD data receiver according to the verification message is received or not, generate an event that the state of the WiHD data projection channel is changed if the response message is not received comprises:
determining whether the response message fed back from the WiHD data receiver according to the verification message is received or not within a preset time;
generating the event that the state of the WiHD data projection channel is changed if the response message is not received within the preset time.

7. A non-transitory computer readable medium storing executable instructions that, when executed by an electronic device, cause the electronic device to:
establish a WiHD data projection channel with a WiHD data receiver;
transmit a verification message to the WiHD data receiver through the WiHD data projection channel;
determine whether a response message fed back from the WiHD data receiver according to the verification message is received or not;
generate an event that the state of the WiHD data projection channel is changed if the response message is not received;
display the prompting indicating that the WiHD data projection channel is shielded according to the event that the state of the WiHD data projection channel is changed.

8. The non-transitory computer readable medium according to claim 7, wherein transmitting a verification message to the WiHD data receiver through the WiHD data projection channel comprises: transmitting the verification message to the WiHD data receiver through the WiHD data projection channel in preset cycles.

9. The non-transitory computer readable medium according to claim 7, wherein determine whether a response message fed back from the WiHD data receiver according to the verification message is received or not, generate an event that the state of the WiHD data projection channel is changed if the response message is not received comprises:
determining whether the response message fed back from the WiHD data receiver according to the verification message is received or not within a preset time;
generating the event that the state of the WiHD data projection channel is changed if the response message is not received within the preset time.
